(19) United States
(12) Patent Application Publication
(10) Pub. No.: US 2026/0083630 A1
(43) Pub. Date: Mar. 26, 2026

(54) VIBROACOUSTIC THERAPY SYSTEM FOR USE IN VEHICLE AND METHOD OF USE

(71) Applicant: TOYOTA BOSHOKU AMERICA, Novi, MI (US)

(72) Inventor: Jeffrey Michael Moran, Linden, MI (US)

(73) Assignee: TOYOTA BOSHOKU AMERICA, Novi, MI (US)

(21) Appl. No.: 19/340,452

(22) Filed: Sep. 25, 2025

Related U.S. Application Data
(60) Provisional application No. 63/699,418, filed on Sep. 26, 2024.

(51) Int. Cl. A61H 23/02

(52) U.S. Cl. CPC A61H 23/0236; A61H 2201/0149; A61H 2201/1607; A61H 2201/1623; A61H 2201/1635; A61H 2201/5048; A61H 2205/081; A61H 2205/086; A61H 2205/102; A61H 2205/106

(57) ABSTRACT

A vibroacoustic therapy seat for use in a vehicle is disclosed. The seat includes an array of small, low-frequency tactile vibroacoustic actuators/transducers are integrated into the seat beneath the trim cover within the foam and seat frame to deliver the appropriate vibrations to the occupant. Multiple actuators create a symmetrical, bi-lateral layout to target the interfacing regions of the body with the seat surface. A headrest with speakers provides supplementing binaural audio to the user synchronized with the vibrations. Each actuator/transducer operates on its own channel allowing for independent control of the parameters of the given actuators/transducer through digital controls. The multi-channel control methodology has several program types with unique patterns, sequencing, and locally targeted controls designed for achieving different responses such as relaxation, energization, sleep induction, or recovery. These programs preset options offered in-vehicle and/or purchased via an “app store” environment based on user preferences.

### CROSS REFERENCE TO RELATED APPLICATION

This application is a U.S. Non-provisional Patent Application of U.S. Provisional Ser. No. 63/699,418 entitled “Vibroacoustic Therapy System For Use In Vehicle and Method of Use,” filed Sep. 26, 2024, which is herein incorporated by reference in its entirety for all purposes.

### TECHNICAL FIELD

The disclosed inventive system and method relates generally to seating for vehicles. More particularly, the disclosed inventive system and method relates to a vibroacoustic therapy seat for use in a wide variety of vehicle applications.

### BACKGROUND OF THE INVENTION

Vibroacoustic therapy is a developing area of sound therapy. According to this therapy, sound waves, typically low frequency sine waves, are passed into the body of a user of the therapy. Introduced in the 1980s, the technology typically utilizes vibration-emitters such as audio speakers to generate low frequency sinusoidal vibrations. Such have been in the range of between about 30 Hz and about 120 Hz. While perhaps not fully understood, it is believed that a mechanism of action making vibroacoustic an effective form of therapy is brainwave entrainment in which a user's brainwaves tend to synchronize with certain rhythms from sensory input.

Today, vibroacoustic devices are provided as beds, pillows, chairs, and wristbands. These devices emit different sounds by way of speakers or transducers which convey the vibrations to the body. Specific areas of the body are generally targeted where the vibration-emitting actuators or transducers are placed generally centric to the medial axis of the body as opposed to positioned bi-laterally for targeting local body regions. Additionally, the size and quantity of the actuators or transducers being used today in vibroacoustic therapy tend to be large in size and few in number, limitations which do not allow for the fidelity or degree of spatial sensation that a broader layout of smaller actuators/transducers would offer.

Known vibroacoustic therapy devices are primarily used in clinics, spas, and resorts. Accordingly, they tend to be restricted in their uses insofar as they are generally designed for clinical or therapeutic use cases. Such applications thus fail to take advantage of treatment opportunities which often involve long periods of sitting, such as in the transportation industry. It is not unusual for an office commute to take in excess of thirty minutes. Airline trips can take much longer, sometimes ten hours or more when travelling internationally. Some effort has been made to introduce vibration solutions into vehicles, but these applications are directed primarily to driver safety applications and infotainment applications and not to improving health and wellness. Accordingly, a need exists for vibroacoustic seating arrangements for use in the transportation setting.

### SUMMARY OF THE INVENTION

The disclosed inventive concept provides a response to the needs of not only extending vibroacoustic therapy into the vehicle setting, but also focus on health and wellness of the seat occupant. The present invention provides a seating arrangement in which a plurality of low-frequency, tactile, vibration-emitting actuators or transducers are strategically placed in the headrest, seat back, and seat base of a vehicle seat. The seat itself may find application in not only the automotive vehicle setting, but also in rail transport and airplanes. The vibration-emitting actuators or transducers are operatively associated with a controller which regulates intensity and the lengths of the waves themselves.

The vibroacoustic arrangement of the present invention provides improved health and wellness of the seat occupant as well as overall therapeutic value based on principles and methodologies of vibroacoustic therapy and sound therapy. Advantageously, the disclosed system and method provides a strategic arrangement or layout of actuators which corresponds to specific anatomy or physiological regions of the occupant's body. The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a side elevational view of a vehicle having vibroacoustic seats according to the disclosed inventive system and method;

FIG. 2 is a perspective view of a vibroacoustic seat of the disclosed inventive system and method;

FIG. 3 is a plan view of a vibroacoustic actuator/transducer for use in the disclosed system and method;

FIG. 4 is a side view of the vibroacoustic actuator/transducer illustrated in FIG. 3; and

FIG. 5 is a sectional view of a vibroacoustic seat according to the disclosed inventive system and method illustrating the positions of the vibroacoustic actuators/transducers relative to the seat frame, foam padding, and seat outer layer.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

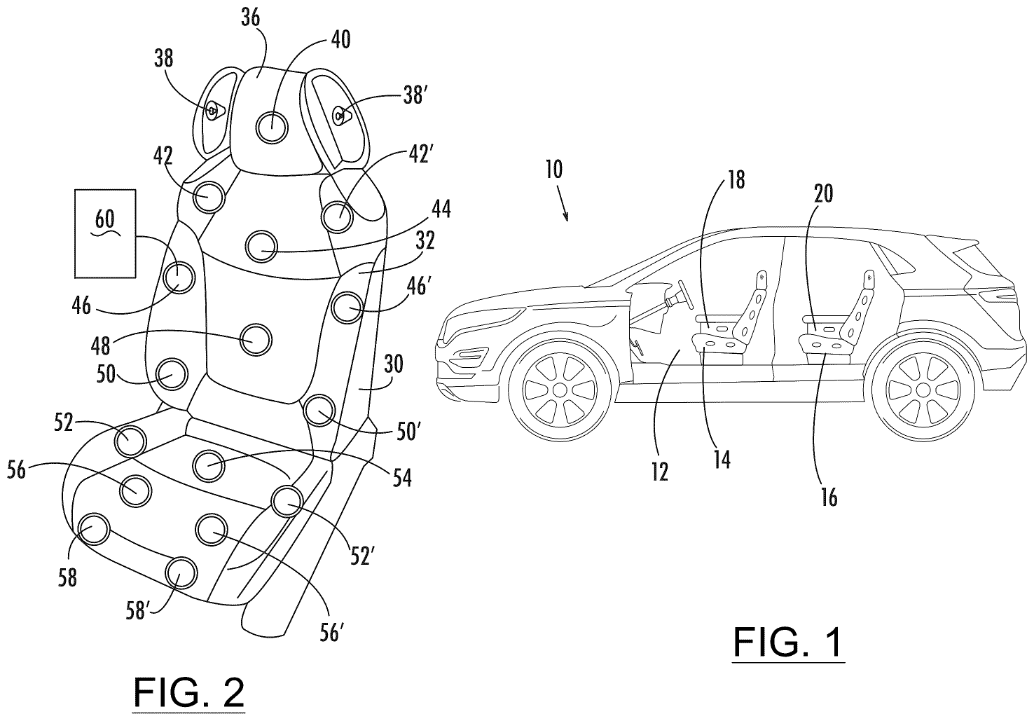

Referring to FIG. 1, a side elevational view of a vehicle having vibroacoustic seats according to the disclosed inventive system and method is illustrated. The vehicle, generally illustrated as 10, is shown as being a passenger vehicle. However, it must be understood that the vibroacoustic seat of the present invention may be fitted to any form of transportation, including aircraft, ships, and planes. Accordingly, the arrangement illustrated in FIG. 1 is intended as being illustrative and not limiting.

The vehicle 10 includes vibroacoustic seats 14 and 16. Optionally associated with the seats 14 and 16 are armrests 18 and 20. Each of the seats 14 and 16 includes a plurality of actuators/transducers which are illustrated and discussed in detail in other figures. The optional armrests 18 and 20 may also include one or more actuators/transducers which may as a further or alternative option be placed in other areas of the vehicle's interior, including, as a non-limiting example, on the headliner, one or more of the pillars, the instrument panel, or the rear window deck.

Referring to FIG. 2, a perspective view of a vibroacoustic seat 30 of the disclosed inventive system and method is illustrated. The vibroacoustic seat 30 includes a seat back 32, a seat base 34, and a head restraint 36 associated with the seat back 32.

The head restraint 36 preferably includes a pair of spaced apart speakers 38 and 38′ provide supplementing binaural audio to the user synchronized with the vibrations generated by the vibroacoustic actuators/transducers 40 through 58′ illustrated in FIG. 2. As illustrated, the multiple actuators create a symmetrical, bi-lateral layout to target the interfacing regions of the body with the seat surface. The actuator/transducer arrangement of the present invention is designed to target specific areas of the posterior anatomy that interfaces with the seat. The locations of the actuator/transducers of FIG. 2 represent potential muscular, vascular, and nervous target regions within the body and may be modified as needed when such variables as occupant size and weight are taken into consideration. The arrangement is designed to ensure the vibrations are pleasantly received by the user in the desired area and are suitable for the targeted therapeutic benefits of vibroacoustic therapy principles.

As illustrated in FIG. 2, the vibroacoustic actuators/transducers are specifically arranged to target areas of the body. The illustrated arrangement is intended as being suggestive and not limiting as it is to be understood that the vibroacoustic actuators/transducers may be changed in number as well as in location. The vibroacoustic actuators/transducers are positioned to create a symmetrical, bi-lateral layout to target the interfacing regions of the occupant's body with the seat surface.

As illustrated, the seat 30 includes an occipital cervical vibroacoustic actuator/transducer 40, left and right scapular vibroacoustic actuators/transducers 42 and 42′ respectively, a thoracic vibroacoustic actuator/transducer 44, left and right latissimus dorsi vibroacoustic actuators/transducers 46 and 46′ respectively, a lumbar vibroacoustic actuator/transducer 48, left and right external oblique vibroacoustic actuators/transducers 50 and 50′ respectively, left and right lateral femoral vibroacoustic actuators/transducers 52 and 52′ respectively, a sacral vibroacoustic actuator/transducer 54, left and right anterior femoral vibroacoustic actuators/transducers 56 and 56′ respectively, and left and right popliteal vibroacoustic actuators/transducers 50 and 50′ respectively.

Each of the vibroacoustic actuators/transducers 40 through 58′ operates on its own channel allowing for independent control of the parameters of the actuators/transducers through digital controls. A controller, such as controller 60, may be used to coordinate control of each of the actuators/transducers. The multi-channel control methodology of the disclosed inventive concept has several different program types with unique patterns, sequencing, and locally targeted controls designed for achieving different responses such as relaxation, energization, sleep induction, recovery, as well as others. Optionally, these programs are offered as a catalog of preset options offered in-vehicle and/or purchased via a “app store” environment based on user preferences.

The independent and digital control methodology of the disclosed concept allows the system to be customized based on the user's personal preference after deployment. If certain actuations are found to be preferred or are determined to be unpleasant, the user can adjust settings within the controls to achieve a more tailored experience. The digital control methodology also allows the system to be updated or improved through software updates that do not require maintenance to hardware components. These updates could be provided manually or through over-the-air (OTA) updates in connected vehicles which adds to the value chain of the product after it is released.

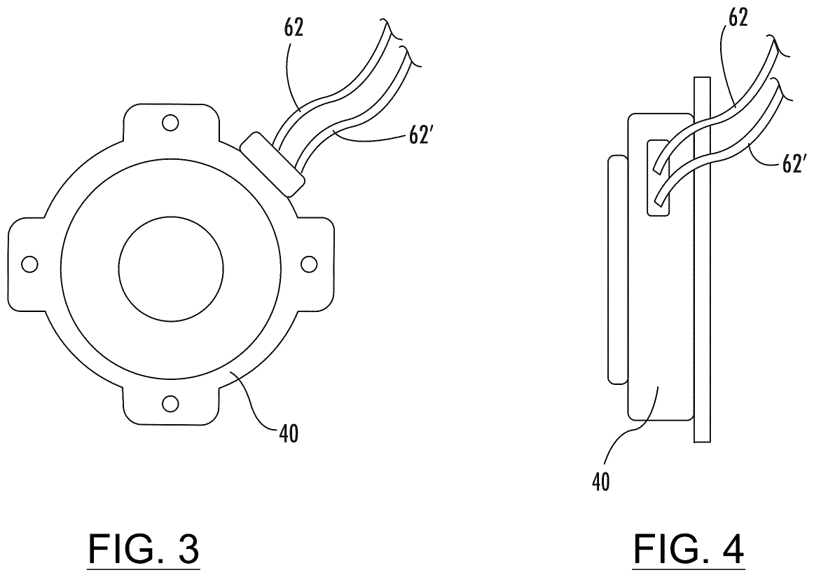

One of the vibroacoustic actuators/transducers shown in FIG. 2 and discussed in relation thereto, the vibroacoustic actuator/transducer 40, is illustrated in a plan view in FIG. 3 and a side view in FIG. 4. It is to be understood that the shape and size of the vibroacoustic actuator/transducer 40 as shown in the figures is only intended as being illustrative and not limiting as other vibroacoustic actuators/transducers may be adapted for use in the present invention. As illustrated, the vibroacoustic actuator/transducer 40 includes lead lines 62 and 62′ which are operatively associated with the controller 60.

In use, the vibroacoustic actuator/transducer 40 produces either mechanical vibrations or low-frequency sound wave vibrations or both. The frequency may be adjusted to maximize effectiveness in providing therapy to the vehicle seat occupant.

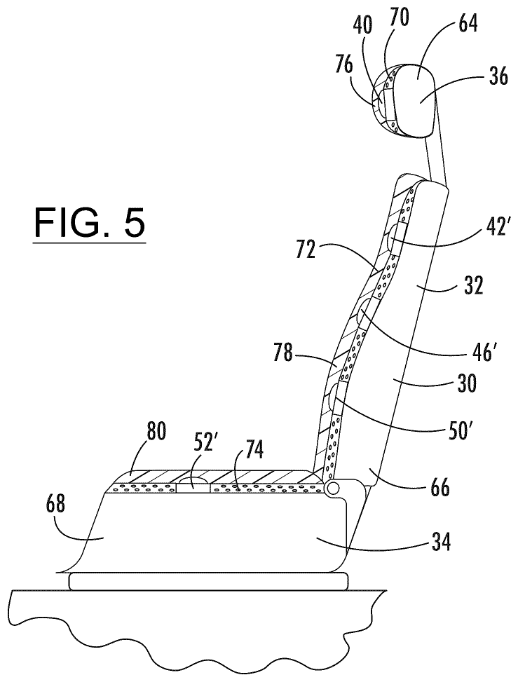

While the vibroacoustic actuators/transducers may be placed in various positions within the vehicle's interior as noted above with respect to FIG. 1, the vibroacoustic actuators/transducers are preferably fitted to the vehicle seat. As illustrated in FIG. 5, the vibroacoustic actuator/transducer 40 is attached to an internal frame 64 of the head restraint 36, the vibroacoustic actuators/transducers 42′, 46′, and 50′ are attached to an internal frame 66 of the seatback 32, and the vibroacoustic actuator/transducer 52′ is attached to an internal frame 68 of the seat base 34. The remaining vibroacoustic actuators/transducers illustrated in FIG. 2 are similarly attached to their respective internal frames.

As illustrated, the vibroacoustic actuator/transducer 40 attached to the head restraint 36 is substantially embedded within a foam padding/PUR foam in-seat cushioning material 70, the vibroacoustic actuators/transducers 42′, 46′, and 50′ are substantially embedded within a foam padding/PUR foam in-seat cushioning material 72, and the vibroacoustic actuator/transducer 52′ is substantially embedded within a foam padding/PUR foam in-seat cushioning material 74. Preferably, all of the vibroacoustic actuators/transducers are similarly embedded within a foam padding/PUR foam in-seat cushioning material.

A trim cover (the A-surface) is fitted to portions of the vibroacoustic seat 30. Specifically, a trim cover 76 is provides substantially over the head restraint 36, s trim cover 78 is provided substantially over the seat back 32, and a trim cover 80 is provided substantially over the seat base 34. The trim covers 76, 78, and 80 may be made from any of a variety of materials, including nylon, leatherette (faux leather), and leather. Other trim cover choices include polyester, neoprene, velour, and canvas. Specifically, a trim cover 76 is provided over the head restraint.

The arrangement described above wherein the vibroacoustic actuators/transducers are embedded within the foam padding/PUR foam in-seat cushioning material and are covered with a trim cover may be optimized to deliver the appropriate vibrations to the occupant.

The seating arrangements disclosed herein have a wide variety of uses which are not limited to the sports stadium. For example, the seating arrangements disclosed and described herein may be used as well in playhouses, movie theaters, and auditoriums. Essentially, the seating arrangements of the present invention may find utility in any setting where spectator seating is required.

The disclosed system and method provide several benefits to the vehicle seat occupant. The advantage of this system is that the arrangement of actuators/transducers is specifically designed for providing vibroacoustic therapy and is embedded in a seat application for vehicles or other mobility forms. Existing vibroacoustic therapy technologies are offered through large bed devices for occupants to lay down or as non-embedded seat solutions that are not for seat applications within vehicles or other forms of mobility. Additionally, the embedded system and spatial arrangement of actuators/transducers allows for targeting specific area of the body more locally as noted above with respect to FIG. 2 which adds value for health and wellness, therapeutic use cases. The primary use case of other vibration systems for vehicles are not health and wellness focused as they are primarily focused on other use cases such as Advanced Driver Assistance Systems (ADAS), Driver Monitoring System (DMS), and Infotainment. These use cases do not require a high-fidelity, anatomically driven actuator/transducer arrangement and thus are not as successful for use in health and wellness applications for vibroacoustic therapy. The disclosed system and method find application in other cases beyond the primary use case for health and wellness benefits based on the layout and multi-channel, digital control methodology proposed.

One skilled in the art will readily recognize from such discussion, and from the accompanying drawings and claims that various changes, modifications and variations can be made therein without departing from the true spirit and fair scope of the invention as defined by the following claims.

1. A vibroacoustic seating system in a vehicle for use by a vehicle occupant, the system comprising:
a seat having a seat surface defined by a seat back and a seat base joined to the seat back;
a plurality of vibration-emitting units embedded in the seat base and seat back;
a controller to which the vibration-emitting units are operatively associated, the vibration units being symmetrically and bi-laterally located to target interfacing areas of the seat occupant's body and the seat surface, whereby the positions of the vibration-emitting units support the health and wellness of the seat occupant.

2. The vibroacoustic seating system of claim 1, wherein the vibration-emitting units are taken from the group consisting of actuators and transducers.

3. The vibroacoustic seating system of claim 1, wherein the seat further includes a head restraint and wherein the head restraint includes at least one vibration-emitting unit.

4. The vibroacoustic seating system of claim 3, wherein the head restraint includes at least one embedded speaker.

5. The vibroacoustic seating system of claim 1, wherein the seating system further includes an armrest, the armrest including at least one embedded vibration-emitting unit.

6. The vibroacoustic seating system of claim 1, wherein the seat back includes a frame and the seat base includes a seat frame joined to the seat frame of the seat back, the vibration-emitting units being attached to one or both of the seat back frame and the seat base frame.

7. The vibroacoustic seating system of claim 6, wherein each of the seat back and the seat base includes a layer of padding whereby the vibration-emitting units are substantially embedded within the padding.

8. The vibroacoustic seating system of claim 7, wherein the seat back and the seat base further include trim covering.

9. A vibroacoustic seating system in a vehicle for use by a vehicle occupant, the system comprising:
a seat having a seat surface defined by a seat back and a seat base joined to the seat back;
a plurality of vibration-emitting units embedded in the seat base and seat back;
a controller to which the vibration-emitting units are operatively associated, the vibration units being positioned to target the seat occupant's specific muscular, vascular, and nervous regions.

10. The vibroacoustic seating system of claim 9, wherein the targeted areas are selected from the group consisting of occipital, cervical, scapular, thoracic, latissimus dorsi, lumbar, external oblique, sacral, femoral, and popliteal regions.

11. The vibroacoustic seating system of claim 9, wherein the vibration-emitting units are taken from the group consisting of actuators and transducers.

12. The vibroacoustic seating system of claim 9, wherein the seat further includes a head restraint and wherein the head restraint includes at least one vibration-emitting unit, the head restraint including at least one embedded speaker.

13. The vibroacoustic seating system of claim 9, wherein the seating system further includes an armrest, the armrest including at least one embedded vibration-emitting unit.

14. The vibroacoustic seating system of claim 9, wherein the seat back includes a frame and the seat base includes a seat frame joined to the seat frame of the seat back, the vibration-emitting units being attached to one or both of the seat back frame and the seat base frame, each seat back and each seat base including a layer of padding whereby the vibration-emitting units are substantially embedded within the padding, the seat back and the seat base further including trim covering.

15. A vibroacoustic seating system for use by a seat occupant, the system comprising:
a seat having a seat surface defined by a seat back and a seat base joined to the seat back;
a plurality of vibration-emitting units embedded in the seat base and seat back;
a controller to which the vibration-emitting units are operatively associated, the vibration units being positioned to target the seat occupant's specific physical regions selected from the group consisting of occipital, cervical, scapular, thoracic, latissimus dorsi, lumbar, external oblique, sacral, femoral, and popliteal regions.

16. The vibroacoustic seating system of claim 15, wherein the vibration-emitting units are taken from the group consisting of actuators and transducers.

17. The vibroacoustic seating system of claim 15, wherein the seat further includes a head restraint and wherein the head restraint includes at least one vibration-emitting unit.

18. The vibroacoustic seating system of claim 15, wherein the seat back includes a frame and the seat base includes a seat frame joined to the seat frame of the seat back, the vibration-emitting units being attached to one or both of the seat back frame and the seat base frame.

19. The vibroacoustic seating system of claim 18, wherein each of the seat back and the seat base includes a layer of padding whereby the vibration-emitting units are substantially embedded within the padding.

20. The vibroacoustic seating system of claim 19, wherein the seat back and the seat base further include trim covering.
